(19) United States
(12) Patent Application Publication
(10) Pub. No.: US 2019/0267618 A1
(43) Pub. Date: Aug. 29, 2019

(54) NON-AQUEOUS ELECTROLYTE SECONDARY BATTERY AND METHOD FOR MANUFACTURING THE SAME

(71) Applicant: SANYO Electric Co., Ltd., Osaka (JP)

(72) Inventors: Fumiya Kanetake, Hyogo (JP); Shinichi Yamami, Hyogo (JP); Naoki Uchida, Hyogo (JP); Kentaro Takahashi, Hyogo (JP)

(73) Assignee: SANYO Electric Co., Ltd., Osaka (JP)

(21) Appl. No.: 16/255,002

(22) Filed: Jan. 23, 2019

(30) Foreign Application Priority Data
Feb. 28, 2018 (JP) 2018-034922

(51) Int. Cl. H01M 4/36; H01M 4/587; H01M 4/62; H01M 10/056; H01M 10/0525

(52) U.S. Cl. CPC H01M 4/366; H01M 4/587; H01M 2300/0091; H01M 10/056; H01M 10/0525; H01M 4/625

(57) ABSTRACT

In a non-aqueous electrolyte secondary battery including a positive electrode: a negative electrode; and a non-aqueous electrolyte, the negative electrode contains: coated graphite particles in each of which a first amorphous carbon and a second amorphous carbon having a higher electrical conductivity than that of the first amorphous carbon are fixed to a surface of a graphite particle; and a carboxymethyl cellulose having a weight average molecular weight of 3.7×10⁵ to 4.3×10⁵ or its salt. The non-aqueous electrolyte contains a difluorophosphate and a lithium salt which converts an oxalato complex to an anion.

### CROSS REFERENCE TO RELATED APPLICATIONS

The present invention application claims priority to Japanese Patent Application No. 2018-034922 filed in the Japan Patent Office on Feb. 28, 2018, the entire contents of which are incorporated herein by reference.

### BACKGROUND OF THE INVENTION

### Field of the Invention

The present disclosure relates to a non-aqueous electrolyte secondary battery and a method for manufacturing the same.

### Description of Related Art

Heretofore, in order to improve battery performance, such as output characteristics, high-temperature storage characteristics, and cycle characteristics, there has been known a non-aqueous electrolyte secondary battery in which lithium difluorophosphate and lithium bis(oxalato)borate are added to a non-aqueous electrolyte liquid (for example, see Japanese Patent No. 5,636,622 (Patent Document 1)). In addition, Japanese Patent No. 5,991,717 (Patent Document 2) has disclosed a non-aqueous electrolyte secondary battery which uses, as a negative electrode active material, non-coated flaky graphite particles each having a non-coated surface; and coated graphite particles in each of which a surface of a graphite particle is coated with a coating layer which contains amorphous carbon particles and an amorphous carbon layer. Patent Document 2 has also disclosed that high-rate charge/discharge cycle characteristics are improved.

### BRIEF SUMMARY OF THE INVENTION

Incidentally, in a non-aqueous electrolyte secondary battery, improvement in high-temperature storage characteristics and low-temperature regeneration characteristics is an important subject. However, it is believed that the techniques disclosed in Patent Documents 1 and 2 are still required to be further improved to satisfy both the high-temperature storage characteristics and the low-temperature regeneration characteristics of the battery.

A non-aqueous electrolyte secondary battery according to one aspect of the present disclosure is a non-aqueous electrolyte secondary battery comprising: a positive electrode: a negative electrode; and a non-aqueous electrolyte, the negative electrode contains: coated graphite particles in each of which a first amorphous carbon and a second amorphous carbon having a higher electrical conductivity than that of the first amorphous carbon are fixed to a surface of a graphite particle; and a carboxymethyl cellulose having a weight average molecular weight of 3.7×10⁵ to 4.3×10⁵ or its salt, and the non-aqueous electrolyte contains a difluorophosphate and a lithium salt which converts an oxalato complex to an anion.

A method for manufacturing a non-aqueous electrolyte secondary battery according to another aspect of the present disclosure is a method for manufacturing a non-aqueous electrolyte secondary battery which includes a positive electrode, a negative electrode, a non-aqueous electrolyte, and a battery case, and the method described above comprises the steps of: forming the negative electrode which contains coated graphite particles in each of which a first amorphous carbon and a second amorphous carbon having a higher electrical conductivity than that of the first amorphous carbon are fixed to a surface of a graphite particle, and a carboxymethyl cellulose having a weight average molecular weight of 3.7×10⁵ to 4.3×10⁵ or its salt; and receiving the non-aqueous electrolyte which contains a difluorophosphate and a lithium salt which converts an oxalato complex to an anion in the battery case.

According to the aspect of the present disclosure, a non-aqueous electrolyte secondary battery excellent in high-temperature storage characteristics and low-temperature regeneration characteristics can be provided.

### BRIEF DESCRIPTION OF THE SEVERAL VIEWS OF THE DRAWINGS

FIG. 1 is a cross-sectional view of a non-aqueous electrolyte secondary battery according to one example of an embodiment;

FIG. 2 is a plan view of the non-aqueous electrolyte secondary battery according to the example of the embodiment;

FIG. 3 is a schematic view of a negative electrode active material according to one example of the embodiment;

FIG. 4 is a schematic view of a negative electrode active material of a comparative example; and

FIG. 5 is a schematic view of a negative electrode active material of another comparative example.

### DETAILED DESCRIPTION OF THE INVENTION

As described above, the improvement in high-temperature storage characteristics and low-temperature regeneration characteristics of the non-aqueous electrolyte secondary battery is an important subject. The present inventors found that when a negative electrode contains: coated graphite particles in each of which a first amorphous carbon and a second amorphous carbon having a higher electrical conductivity than that of the first amorphous carbon are fixed to a surface of a graphite particle; and a carboxymethyl cellulose having a weight average molecular weight of 3.7×10⁵ to 4.3×10⁵ or its salt, and when a difluorophosphate and a lithium salt which converts an oxalato complex to an anion are added to a non-aqueous electrolyte, the high-temperature storage characteristics and the low-temperature regeneration characteristics can be remarkably improved.

It has been known that when a difluorophosphate and a lithium salt which converts an oxalato complex to an anion are added to a non-aqueous electrolyte, a good quality protective coating film is formed on a surface of each particle of a negative electrode active material. However, only by the addition of those salts, it is difficult to uniformly form the protective coating film on the surface of the negative electrode active material, and on the contrary, for example, the low-temperature regeneration characteristics may be degraded in some cases. Hence, the present inventors conceived that when coated graphite particles which have a high electrical conductivity and which are formed from graphite particles each having a surface coated with two types of amorphous carbons are used as a negative electrode active material, a good quality protective coating film is uniformly formed on the surface of the negative electrode active material (the coated graphite particles), and the low-temperature regeneration characteristics can be improved. Furthermore, the present inventors also conceived that when the surface of the second amorphous carbon is coated with a carboxymethyl cellulose having a specific molecular weight or its salt, a reaction between the second amorphous carbon and the non-aqueous electrolyte can be effectively suppressed in a high temperature atmosphere, and the high-temperature storage characteristics can be improved.

When at least one of the two types of amorphous carbons is not present, when the difluorophosphate and the lithium salt which converts an oxalato complex to an anion are not present, and/or when the carboxymethyl cellulose having a weight average molecular weight of 3.7×10⁵ to 4.3×10⁵ or its salt is not present, the high-temperature storage characteristics and/or the low-temperature regeneration characteristics cannot reach a satisfactory level. That is, only when the negative electrode which contains the coated graphite particles described above and the carboxymethyl cellulose having a specific molecular weight or its salt is used, and the difluorophosphate and the lithium salt which converts an oxalato complex to an anion are added to the non-aqueous electrolyte, the high-temperature storage characteristics and the low-temperature regeneration characteristics are specifically improved.

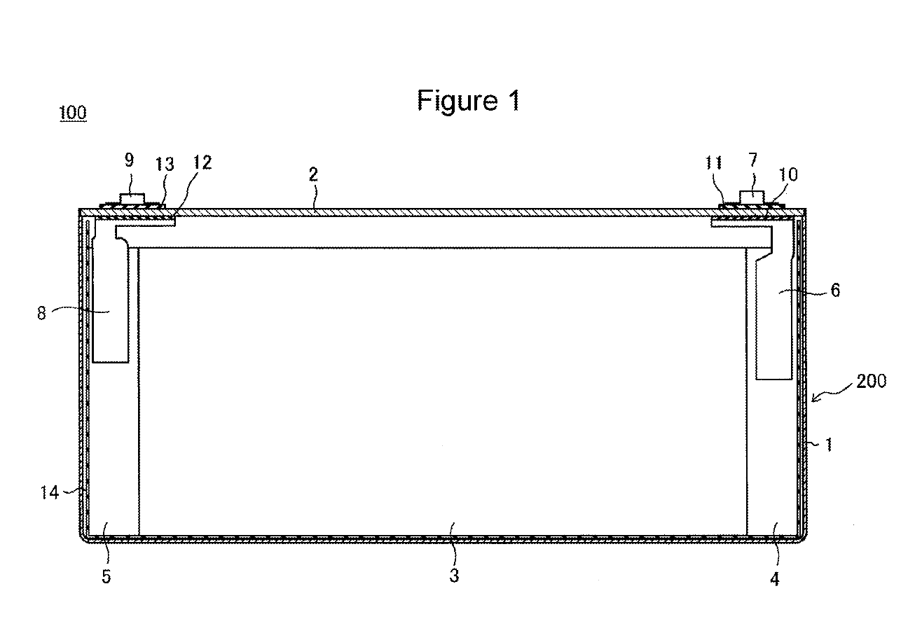

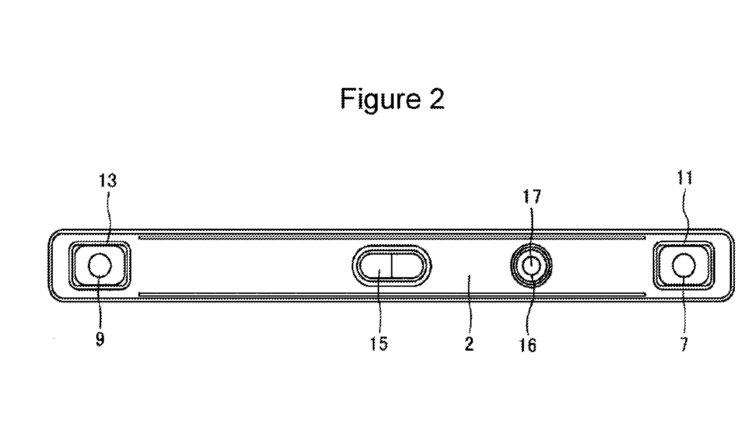

Hereinafter, with reference to the drawings, one example of an embodiment of the present disclosure will be described in detail. FIGS. 1 and 2 each show, as one example of the embodiment, a non-aqueous electrolyte secondary battery 100 which is a square battery including a square battery case 200. However, the non-aqueous electrolyte secondary battery according to the present disclosure may be a cylindrical battery including a cylindrical metal case, a coin battery including a coin-shaped metal case, or a laminate battery including an exterior body formed by a laminate sheet having at least one metal layer and at least one resin layer. In addition, as an electrode body, although an electrode body 3 having a winding structure is shown by way of example, the electrode body may have a laminate structure in which positive electrodes and negative electrodes are alternately laminated to each other with separators interposed therebetween.

As shown in FIGS. 1 and 2, the non-aqueous electrolyte secondary battery 100 includes a bottomed square exterior can 1 and a sealing plate 2 sealing an opening of the exterior can 1. By the exterior can 1 and the sealing plate 2, the battery case 200 is formed. The exterior can 1 receives a flat electrode body 3 formed by winding a belt-shaped positive electrode and a belt-shaped negative electrode with belt-shaped separators interposed therebetween and a non-aqueous electrolyte liquid. The electrode body 3 has a positive electrode core exposing portion 4 formed at one axially directed end portion and a negative electrode core exposing portion 5 formed at the other axially directed end portion.

To the positive electrode core exposing portion 4, a positive electrode collector 6 is connected, and the positive electrode collector 6 and a positive electrode terminal 7 are electrically connected to each other. Between the positive electrode collector 6 and the sealing plate 2, an internal insulating member 10 is disposed, and between the positive electrode terminal 7 and the sealing plate 2, an external insulating member 11 is disposed. To the negative electrode core exposing portion 5, a negative electrode collector 8 is connected, and the negative electrode collector 8 and a negative electrode terminal 9 are electrically connected to each other. Between the negative electrode collector 8 and the sealing plate 2, an internal insulating member 12 is disposed, and between the negative electrode terminal 9 and the sealing plate 2, an external insulating member 13 is disposed.

Between the electrode body 3 and the exterior can 1, an insulating sheet 14 is disposed so as to envelop the electrode body 3. In the sealing plate 2, a gas discharge valve 15 is provided which is fractured when the pressure in the battery case 200 reaches a predetermined value or more and which discharges a gas in the battery case 200 to the outside. In addition, in the sealing plate 2, an electrolyte liquid charge hole 16 is provided. The electrolyte liquid charge hole 16 is sealed by a sealing plug 17 after the non-aqueous electrolyte liquid is charged in the exterior can 1.

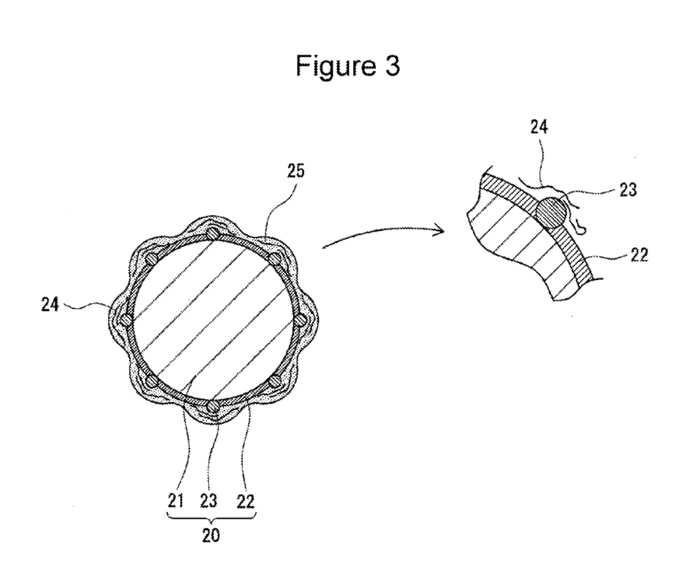

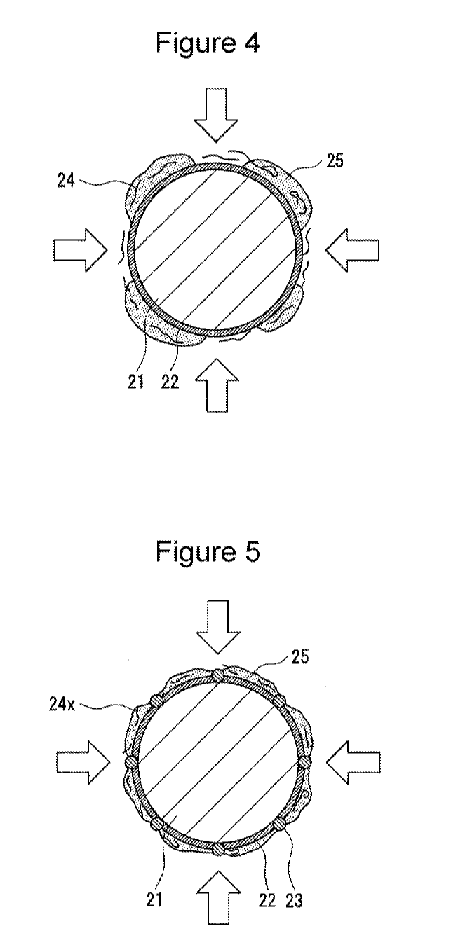

Hereinafter, with appropriate reference to FIGS. 3 to 5, the electrode body 3 and the non-aqueous electrolyte forming the non-aqueous electrolyte secondary battery 100, in particular, the negative electrode and the non-aqueous electrolyte, will be described in detail. FIG. 3 is schematic view showing a negative electrode active material (coated graphite particle 20) which is one example of the embodiment. FIGS. 4 and 5 are schematic views showing negative electrode active materials formed in Comparative Examples 1 and 5, respectively, which will be described later. FIGS. 3 to 5 each show one example of the state which is predicted by the present inventors and are each only an imaginary view.

### [Positive Electrode]

The positive electrode includes a positive electrode core and at least one positive electrode mixture layer provided on the positive electrode core. For the positive electrode core, for example, foil of a metal, such as aluminum, stable in a potential range of the positive electrode or a film provided with the metal mentioned above as a surface layer may be used. The positive electrode mixture layer contains a positive electrode active material, an electrically conductive material, and a binding agent and is preferably provided on each of two surfaces of the positive electrode core. The positive electrode can be formed, for example, in such a way that after a positive electrode mixture slurry containing the positive electrode active material, the electrically conductive material, the binding agent, and the like is applied on the positive electrode core, coating films thus formed are dried and then compressed, so that the positive electrode mixture layers are formed on the two surfaces of the positive electrode core.

The positive electrode active material contains a lithium metal composite oxide as a primary component. As a metal element contained in the lithium metal composite oxide, for example, there may be mentioned Ni, Co, Mn, Al, B, Mg, Ti, V, Cr, Fe, Cu, Zn, Ga, Sr, Zr, Nb, In, Sn, Ta, and W. One example of a preferable lithium metal composite oxide is a lithium metal composite oxide containing at least one of Ni, Co, and Mn. As a particular example, for example, there may be mentioned a lithium metal composite oxide containing Ni, Co, and Mn or a lithium metal composite oxide containing Ni, Co, and Al. In addition, to a surface of a particle of the lithium metal composite oxide, particles of an inorganic compound, such as a tungsten oxide, an aluminum oxide, and/or a compound containing lanthanoid, may be fixed.

As the electrically conductive material contained in the positive electrode mixture layer, for example, there may be mentioned a carbon material, such as carbon black, acetylene black, Ketjen black, or graphite. As the binding agent contained in the positive electrode mixture layer, for example, there may be mentioned a fluorine resin, such as a polytetrafluoroethylene (PTFE) or a poly(vinylidene fluoride) (PVdF); a polyacrylonitrile (PAN), a polyimide resin, an acrylic resin, or a polyolefin resin. Those resins each may be used together with a cellulose derivative, such as a carboxymethyl cellulose (CMC) or its salt, a polyethylene oxide (PEO), or the like.

### [Negative Electrode]

The negative electrode includes a negative electrode core and at least one negative electrode mixture layer provided on the negative electrode core. For the negative electrode core, for example, foil of a metal, such as copper, stable in a potential range of the negative electrode or a film provided with the metal mentioned above as a surface layer may be used. The negative electrode mixture layer includes a negative electrode active material and a binding agent and is preferably provided on each of two surfaces of the negative electrode core. The negative electrode can be formed, for example, in such a way that after a negative electrode mixture slurry including the negative electrode active material, the binding agent, and the like is applied on the negative electrode core, coating films thus formed are dried and then compressed, so that the negative electrode mixture layers are formed on the two surfaces of the negative electrode core.

Although the details will be described later, the negative electrode contains: coated graphite particles in each of which a first amorphous carbon and a second amorphous carbon having a higher electrical conductivity than that of the first amorphous carbon are fixed to a surface of a graphite particle; and a carboxymethyl cellulose having a weight average molecular weight (Mw) of 3.7×10⁵ to 4.3×10⁵ or its salt. In this specification, Mw indicates a value measured by a gel permeation chromatography (GPC).

In the negative electrode mixture layer, as the negative electrode active material, coated graphite particles 20 (see FIG. 3) are contained. The coated graphite particle 20 is a particle in which two types of amorphous carbons are fixed to a surface of a graphite particle 21 formed from natural graphite, such as flaky graphite, massive graphite, or earthy graphite, or artificial graphite, such as massive artificial graphite (MAG) or graphitized mesophase carbon microbeads (MCMB). In addition, as long as the advantage of the present disclosure is not degraded, a metal, such as Si, forming an alloy with lithium, an alloy containing the metal, and/or a compound containing the metal may also be used for the negative electrode active material. As a negative electrode active material other than the graphite, for example, a silicon oxide, such as SiOₓ, may be mentioned.

As shown by way of example in FIG. 3, the coated graphite particle 20 is formed of the graphite particle 21 and the two types of amorphous carbons fixed to the surface of the graphite particle 21. The coated graphite particle 20 is a core-shell particle in which, for example, the graphite particle 21 is used as a core, and the two types of amorphous carbons are used as a shell. As the two types of amorphous carbons, as described above, the first amorphous carbon and the second amorphous carbon having a higher electrical conductivity than that of the first amorphous carbon are used. An amorphous carbon coating film 22 is preferably formed from the first amorphous carbon on the surface of the graphite particle 21, and amorphous carbon particles 23 formed from the second amorphous carbon are preferably fixed to the surface of the graphite particle 21.

The coated graphite particle 20 has a higher electrical conductivity than that of the graphite particle 21 by the function of the amorphous carbons. By a synergetic effect among the coated graphite particles 20 having a high electrical conductivity, a CMC 24, and the difluorophosphate and the lithium salt which converts an oxalato complex to an anion, a good quality protective coating film 25 is uniformly formed on the surface of the coated graphite particle 20. In this case, the CMC 24 indicates a carboxymethyl cellulose having an Mw of 3.7×10⁵ to 4.3×10⁵ or its salt.

The amorphous carbon coating film 22 is preferably formed so as to coat the entire surface of the graphite particle 21. The amorphous carbon coating film 22 is formed as a continuous layer coating the entire surface of the graphite particle 21 so as not to expose the surface thereof. On the other hand, the amorphous carbon particles 23 are dispersed on the surface of the graphite particle 21. The amorphous carbon particles 23 are uniformly fixed to the entire surface of the graphite particle 21 without being localized on a part of the surface thereof.

The first amorphous carbon forming the amorphous carbon coating film 22 is, for example, a fired product of pitch. The pitch may be either petroleum pitch or coal pitch. The amorphous carbon coating film 22 is formed, for example, in such a way that after the pitch is adhered to the entire surfaces of the graphite particles 21, firing is performed in an inert atmosphere at a temperature of 900° C. to 1,500° C. or preferably 1,200° C. to 1,300° C. A mass rate of the amorphous carbon coating film 22 of the coated graphite particle 20 is, with respect to the total mass of the coated graphite particle 20, preferably 1 to 10 percent by mass and more preferably 2 to 5 percent by mass.

The amorphous carbon particles 23 may be directly fixed to the surface of the graphite particle 21 or may be fixed to the surface of the graphite particle 21 with the amorphous carbon coating film 22 interposed therebetween. In addition, the amorphous carbon particles 23 may be coated with the amorphous carbon coating film 22. For example, some amorphous carbon particles 23 may be embedded in the amorphous carbon coating film 22. As shown by way of example in FIG. 3, the surface of the amorphous carbon particle 23 may be partially exposed without being coated with the amorphous carbon coating film 22.

The second amorphous carbon forming the amorphous carbon particles 23 is, for example, carbon black. Since having a high electrical conductivity and a small change in volume during charge/discharge, carbon black is preferably used as the amorphous carbon particles 23. The average grain diameter of the amorphous carbon particles 23 is, for example, 30 to 100 nm. The average grain diameter is calculated in such a way that after 100 amorphous carbon particles 23 are selected from an electron microscope image of the amorphous carbon particles 23, the maximum span lengths of the particles thus selected are measured, and the measured values are averaged. In addition, a dibutyl phthalate (DBP) absorption amount of the amorphous carbon particles 23 is, for example, 35 to 220 mL/100 g.

A mass rate of the amorphous carbon particles 23 of the coated graphite particle 20 is preferably higher than the mass rate of the amorphous carbon coating film 22. That is, on the mass basis, a large amount of the second amorphous carbon is present on the surface of the graphite particle 21 as compared to that of the first amorphous carbon. The mass rate of the amorphous carbon particles 23 with respect to the total mass of the coated graphite particle 20 is preferably 2 to 15 percent by mass and more preferably 5 to 9 percent by mass.

In addition, the presence of the amorphous carbon can be confirmed by Raman spectroscopic measurement. A peak at around 1,360 cm⁻¹ of a Raman spectroscopic spectrum using an argon laser having a wavelength 5,145 Å is a peak derived from amorphous carbon and is hardly observed in graphite carbon. On the other hand, a peak at around 1,580 cm⁻¹ is a specific peak of graphite carbon. As for the ratio (I₁₃₆₀/I₁₅₈₀) of a peak intensity (I₁₃₆₀) at around 1,360 cm⁻¹ to a peak intensity (I₁₅₈₀) at around 1,580 cm⁻¹, for example, the graphite particle 21 has 0.10 or less, and the coated graphite particle 20 has 0.13 or more.

A central particle diameter (D50) of the coated graphite particles 20 is, for example, 5 to 20 μm and preferably 8 to 13 μm. The central particle diameter indicates a median diameter at a cumulative volume of 50% in a particle size distribution measured by a laser diffraction scattering particle size distribution measurement apparatus (such as LA-750 manufactured by HORIBA, Ltd.). When the central particle diameter (D50) of the coated graphite particles 20 is in the range as described above, coating properties of the negative electrode mixture slurry are improved, and an adhesion strength of the mixture layer to the core is further increased. In addition, the number of contact points between the particles can be increased, and hence, the electrical conductivity of the negative electrode mixture layer is further improved.

A BET specific surface area of the coated graphite particles 20 is, for example, 4 to 8 m²/g and preferably 4 to 6 m²/g. When the BET specific surface area is in the range described above, a side reaction of the electrolyte liquid can be easily suppressed, and an effect of improving the high-temperature storage characteristics and the low-temperature regeneration characteristics is further enhanced. In addition, a tapped bulk density of the coated graphite particles 20 is, for example, 0.9 g/cc or more. In this case, preferable coating properties of the negative electrode mixture slurry can be obtained, and the adhesion strength of the mixture layer to the core tends to be improved. The tapped bulk density can be calculated from an apparent volume which is obtained in such a way that after 50 g of the coated graphite particles 20 is charged in a measuring cylinder, tapping is performed 700 times, and the apparent volume is then measured.

In the negative electrode mixture layer, as described above, the CMC 24, which is a carboxymethyl cellulose having an Mw of 3.7×10⁵ to 4.3×10⁵ or its salt, is contained. As the salt of the carboxymethyl cellulose, for example, a sodium carboxymethyl cellulose or an ammonium carboxymethyl cellulose may be mentioned. As one preferable example of the CMC 24 is a sodium carboxymethyl cellulose (CMC-Na). The CMC 24 may also function as a binding agent or may also have a viscosity adjusting function of the negative electrode mixture slurry.

As shown by way of example in FIG. 3, the CMC 24 is adhered to the surface of the coated graphite particle 20. That is, the CMC 24 coats the amorphous carbons present as a surface layer of the coated graphite particle 20. In particular, since the surfaces of the amorphous carbon particles 23 are coated with the CMC 24, a reaction between the amorphous carbon particles 23 and the non-aqueous electrolyte can be effectively suppressed in a high-temperature atmosphere. Hence, the high-temperature storage characteristics are improved. Since having a high affinity to the amorphous carbon particles 23, the CMC 24, which has an Mw of 3.7×10⁵ to 4.3×10⁵, efficiently coats the amorphous carbon particles 23. In addition, when the Mw of the CMC 24 is less than 3.7×10⁵, the amorphous carbon particles 23 cannot be sufficiently coated, and as a result, the side reaction is liable to occur. On the other hand, when the Mw of the CMC 24 is more than 4.3×10⁵, the CMC 24 is not likely to be dissolved in the negative electrode mixture slurry, and as a result, a preferable negative electrode mixture layer having no pinholes is difficult to form.

The content of the CMC 24 with respect to the total mass of the negative electrode mixture layer is preferably 0.1 to 1 percent by mass and more preferably 0.2 to 0.8 percent by mass. In addition, 0.1 to 1 part by mass of the CMC 24 is preferably present per 100 parts by mass of the coated graphite particles 20. In this case, the amorphous carbon of the coated graphite particle 20 can be efficiently coated with the CMC 24. In the negative electrode mixture layer, for example, on the mass basis, a large amount of the CMC 24 is contained as compared to that of a binding agent, such as an SBR, which will be described below.

The negative electrode mixture layer preferably contains, as a binding agent, a styrene-butadiene rubber (SBR), a polyacrylic acid (PAA) or its salt, or a poly(vinyl alcohol). As the binding agent, for example, although a fluorine resin, a PAN, a polyimide resin, an acrylic resin, or a polyolefin resin, which are similar to those for the positive electrode, may also be used, an SBR is preferably used. The content of the binding agent, such as an SBR, with respect to the total mass of the negative electrode mixture layer is preferably 0.05 to 1 percent by mass and more preferably 0.1 to 0.5 percent by mass.

On the surface of the coated graphite particle 20, as described above, the good quality protective coating film 25 is uniformly formed. The protective coating film 25 is believed to be uniformly formed over the entire surface of the coated graphite particle 20. The uniform protective coating film 25 suppresses the side reaction on the surface of the coated graphite particle 20 and improves the high-temperature storage characteristics and the low-temperature regeneration characteristics of the battery.

In addition, as shown by way of example in FIG. 4, when the amorphous carbon particles 23, which is the second amorphous carbon, are not present, or as shown by way of example in FIG. 5, when a CMC 24x having an Mw of less than 3.7×10⁵ is used, it is believed that the uniform protective coating film 25 cannot be formed over the entire surface of the coated graphite particle 20, and that the amorphous carbon is exposed. When the amorphous carbon particles 23 are not present, it is believed that since electron conductivity of the surface of the active material is decreased, the protective coating film 25 is not uniformly formed, and the sub reaction of the electrolyte liquid is liable to occur on the surface of the active material. When the CMC 24x is used, it is believed that active points of the amorphous carbon particles 23 are exposed, and hence, the side reaction is liable to occur. In addition, in the case in which the difluorophosphate and the lithium salt which converts an oxalato complex to an anion are not present, the protective coating film 25 is also not uniformly formed.

### [Separator]

As the separator, a porous sheet having ion permeability and insulating properties is used. As a particular example of the porous sheet, for example, a fine porous thin film, a woven cloth, or a non-woven cloth may be mentioned. As a material of the separator, for example, an olefin resin, such as a polyethylene or a polypropylene, or a cellulose is preferable. The separator may have either a monolayer structure or a multilayer structure. On the surface of the separator, for example, a heat resistant layer may also be formed.

### [Non-Aqueous Electrolyte]

The non-aqueous electrolyte contains a non-aqueous solvent and an electrolyte salt. As the non-aqueous solvent, for example, there may be used an ester, an ether, a nitrile, such as acetonitrile, an amide, such as dimethylformamide, or a mixed solvent containing at least two of those mentioned above. As the non-aqueous solvent, a halogen-substituted material may also be used which is obtained by substituting at least one hydrogen atom of the solvent mentioned above by a halogen atom, such as fluorine. As the halogen-substituted material, for example, there may be mentioned a fluorinated cyclic carbonate ester, such as fluoroethylene carbonate (FEC), a fluorinated chain carbonate ester, or a fluorinated chain carboxylic acid ester, such as methyl fluoropropionate (FMP).

The non-aqueous electrolyte contains, as the electrolyte salt dissolved in the non-aqueous solvent, a difluorophosphate and a lithium salt which converts an oxalato complex to an anion. As described above, by the synergetic effect among the coated graphite particles 20, the CMC 24, and the difluorophosphate and the lithium salt which converts an oxalato complex to an anion, the good quality protective coating film 25 is uniformly formed on the surface of the coated graphite particle 20, and as a result, the low-temperature regeneration characteristics of the battery can be improved.

Although the difluorophosphate may be a salt of a metal other than lithium, lithium difluorophosphate (LiPF₂O₂) is preferable. In addition, as the lithium salt which converts an oxalato complex to an anion, lithium bis(oxalato)borate (LiBOB) is preferable. The concentration of the difluorophosphate is preferably 0.01 to 1.0 mole and more preferably 0.02 to 0.1 moles per one liter of the non-aqueous solvent. The concentration of the lithium salt which converts an oxalato complex to an anion is, for example, lower than the concentration of the difluorophosphate and is preferably 0.005 to 0.1 moles and more preferably 0.01 to 0.05 moles per one liter of the non-aqueous solvent.

In the non-aqueous electrolyte, another lithium salt other than the difluorophosphate and the lithium salt which converts an oxalato complex to an anion may also be contained. As a particular example of the another lithium salt, for example, there may be mentioned LiBF₄, LiClO₄, LiPF₆, LiAsF₆, LiSbF₆, LiAlCl₄, LiSCN, LiCF₃SO₃, LiCF₃CO₂, Li(P(C₂O₄)F₄), or LiPF₆₋ₓ(CₙF₂ₙ₊₁)ₓ (1<x<6, n indicates 1 or 2). Among those mentioned above, in view of ion conductivity, electrochemical stability, and the like, LiPF₆ is preferably used. The concentration of the another lithium salt, such as LiPF₆, is, for example, 0.8 to 1.8 moles per one liter of the non-aqueous solvent.

As an example of the ester described above, for example, there may be mentioned a cyclic carbonate ester, such as ethylene carbonate (EC), propylene carbonate (PC), or butylene carbonate; a chain carbonate ester, such as dimethyl carbonate (DMC), methyl ethyl carbonate (MEC), diethyl carbonate (DEC), methyl propyl carbonate, ethyl propyl carbonate, or methyl isopropyl carbonate: a cyclic carboxylic acid ester, such as γ-butyrolactone (GBL) or γ-valerolactone (GVL); or a chain carboxylic acid ester, such as methyl acetate, ethyl acetate, propyl acetate, methyl propionate (MP), or ethyl propionate. Among those mentioned above, at least one selected from EC, MEC, and DMC is preferably used.

As an example of the ether described above, for example, there may be mentioned a cyclic ether, such as 1,3-dioxolane, 4-methyl-1,3-dioxolane, tetrahydrofuran, 2-methyltetrahydrofuran, propylene oxide, 1,2-butylene oxide, 1,3-dioxane, 1,4-dioxane, 1,3,5-trioxane, furan, 2-methylfuran, 1,8-cineol, or a crown ether; or a chain ether, such as 1,2-dimethoxyethane, diethyl ether, dipropyl ether, diisopropyl ether, dibutyl ether, dihexyl ether, ethyl vinyl ether, butyl vinyl ether, methyl phenyl ether, ethyl phenyl ether, butyl phenyl ether, pentyl phenyl ether, methoxytoluene, benzyl ethyl ether, diphenyl ether, dibenzyl ether, o-dimethoxybenzen, 1,2-diethoxyethane, 1,2-dibutoxyethane, diethylene glycol dimethyl ether, diethylene glycol diethyl ether, diethylene glycol dibutyl ether, 1,1-dimethoxymethane, 1,1-diethoxyethane, triethylene glycol dimethyl ether, or tetraethylene glycol dimethyl ether.

### EXAMPLES

Hereinafter, although the present disclosure will be further described with reference to Examples, the present disclosure is not limited thereto.

### Example 1

### [Formation of Positive Electrode]

As a positive electrode active material, a composite oxide represented by LiNi_{0.35}CO_{0.35}Mn_{0.30}O₂ was used. After the positive electrode active material, a PVdF, and carbon black were mixed together at a mass ratio of 90:3:7, kneading was performed while N-methyl-2-pyrollidone was added, so that a positive electrode mixture slurry was prepared. Next, the positive electrode slurry was applied on two surface of a long rectangular positive electrode core formed from aluminum foil having a thickness of 13 μm, and coating films thus obtained were dried. The dried coating films were each compressed to have a packing density of 2.5 g/cm³ and were then cut to have a predetermined electrode size, so that a positive electrode having a positive electrode mixture layer on each of the two surfaces of the positive electrode core was formed. In addition, in the positive electrode, a positive electrode core exposing portion to be connected to a positive electrode collector was provided at one axially directed end portion in a longitudinal direction of the positive electrode.

### [Formation of Coated Graphite Particles]

After graphite particles obtained from natural graphite by reforming to have spherical shapes and carbon black, which was the second amorphous carbon, were mechanically mixed together to form mixed particles in which carbon black particles were fixed to the surfaces of the graphite particles, pitch (precursor of the first amorphous carbon) was added to and mixed with the above mixed particles, so that the pitch was adhered to the surfaces of the mixed particles. The graphite particles, the pitch, and the carbon black were mixed together at a mass ratio of 90:3:7. After the graphite particles each having a surface to which the pitch and the carbon black were adhered were fired at 1,250° C. for 24 hours in an inert gas atmosphere, a fired product thus obtained was crushed, so that coated graphite particles in each of which a fired product of the pitch, which was the first amorphous carbon, and the carbon black were fixed to the surface of the graphite particle were formed.

The central particle diameter (D50) of the coated graphite particles described above was 11 μm, and the BET specific surface area was 5.5 m²/g. In the coated graphite particle, the fired product of the pitch coated the entire surface of the graphite particle to form an amorphous carbon coating film, and the carbon black particles were uniformly fixed to the surface of the graphite particle.

### [Formation of Negative Electrode]

As a negative electrode active material, the coated graphite particles described above were used. After the negative electrode active material and a CMC-Na having an Mw of 4.0×10⁵ were mixed together and then kneaded while water was added, a dispersion of an SBR was further added, so that a negative electrode mixture slurry was prepared. The negative electrode active material, the CMC, and the SBR dispersion were mixed at a mass ratio of 99.3:0.5:0.2. Subsequently, after the negative electrode mixture slurry was applied on two surfaces of a long rectangular negative electrode core formed from copper foil having a thickness of 8 μm, coating film thus formed were dried. The dried coating films were each compressed to have a packing density of 1.0 g/cm³ and were then cut to have a predetermined electrode size, so that a negative electrode having a negative electrode mixture layer on each of the two surfaces of the negative electrode core was formed. In addition, in the negative electrode, a negative electrode core exposing portion to be connected to a negative electrode collector was provided at one axially directed end portion in a longitudinal direction of the negative electrode.

The packing density of the mixture layer of each of the positive electrode and the negative electrode was obtained by the following method.

(1) An electrode plate is prepared by cutting to have a size of 10 cm², and a mass A (g) and a thickness C (cm) of the electrode plate thus prepared are measured.
(2) The mixture layer is peeled away from the electrode plate thus prepared, and a mass B (g) and a thickness D (cm) of the core are measured.
(3) The packing density is calculated by the following equation.

Packing density (g/cm³)=(A−B)/[(C−D)×10].

### [Preparation of Non-Aqueous Electrolyte Liquid]

In a mixed solvent obtained by mixing EC, MEC, and DMC at a volume ratio of 3:3:4 (at one atmospheric pressure and 25° C.), LiPF₆, LiBOB, and LiPF₂O₂ were dissolved to have concentrations of 1.15 M, 0.025 M, and 0.05 M, respectively, so that a non-aqueous electrolyte liquid was prepared.

### [Formation of Non-Aqueous Electrolyte Secondary Battery]

The positive electrode and the negative electrode were wound with long rectangular polyolefin-made separators interposed therebetween and were then press-molded to have a flat shape, so that a flat winding type electrode body was formed. In this case, the positive electrode and the negative electrode were wound so that the positive electrode core exposing portion was located at one axially directed end portion of the electrode body and the negative electrode core exposing portion was located at the other axially directed end portion thereof. After the positive electrode collector and the negative electrode collector were welded to the positive electrode core exposing portion and the negative electrode core exposing portion, respectively, the electrode body was inserted into a square exterior can, and the collectors were connected to respective terminals. After a sealing plate was fitted to an opening portion of the exterior can, and the non-aqueous electrolyte liquid described above was charged therein through an electrolyte liquid charge hole of the sealing plate, the charge hole was sealed with a sealing plug, so that a non-aqueous electrolyte secondary battery having a rated capacity of 4.1 Ah was obtained.

### Example 2

Except for that in the formation of the negative electrode, a CMC-Na having an Mw of 3.7×10⁵ was used instead of using the CMC-Na having an Mw of 4.0×10⁵, a battery was formed in a manner similar to that of Example 1.

### Example 3

Except for that in the formation of the negative electrode, a CMC-Na having an Mw of 4.3×10⁵ was used instead of using the CMC-Na having an Mw of 4.0×10⁵, a battery was formed in a manner similar to that of Example 1.

### Comparative Example 1

Except for that as the negative electrode active material, the following coated graphite particles were used instead of using the coated graphite particles of Example 1, a battery was formed in a manner similar to that of Example 1.

Pitch (precursor of the first amorphous carbon) was added to and mixed with graphite particles obtained from natural graphite by reforming to have spherical shapes so as to be adhered to the surfaces of the graphite particles. The graphite particles and the pitch were mixed together at a mass ratio of 97:3. After the graphite particles each having a surface to which the pitch was adhered were fired at 1,250° C. for 24 hours in an inert gas atmosphere, a fired product thus obtained was crushed, so that coated graphite particles in each of which a fired product of the pitch, which was the first amorphous carbon, was fixed to the surface of the graphite particle were formed. The central particle diameter (D50) of the coated graphite particles described above was 11 μm, and the BET specific surface area thereof was 4.7 m²/g. In addition, the fired product of the pitch coated the entire surface of the graphite particle to form an amorphous carbon coating film.

### Comparative Example 2

Except for that in the formation of the negative electrode, a CMC-Na having an Mw of 3.3×10⁵ was used instead of using the CMC-Na having an Mw of 4.0×10⁵, a battery was formed in a manner similar to that of Comparative Example 1.

### Comparative Example 3

Except for that LiBOB and LiPF₂O₂ were not added to the non-aqueous electrolyte liquid, a battery was formed in a manner similar to that of Comparative Example 1.

### Comparative Example 4

Except for that in the formation of the negative electrode, a CMC-Na having an Mw of 3.3×10⁵ was used instead of using the CMC-Na having an Mw of 4.0×10⁵, a battery was formed in a manner similar to that of Comparative Example 3.

### Comparative Example 5

Except for that in the formation of the negative electrode, a CMC-Na having an Mw of 3.3×10⁵ was used instead of using the CMC-Na having an Mw of 4.0×10⁵, a battery was formed in a manner similar to that of Example 1.

### Comparative Example 6

Except for that LiBOB and LiPF₂O₂ were not added to the non-aqueous electrolyte liquid, a battery was formed in a manner similar to that of Example 1.

### Comparative Example 7

Except for that in the formation of the negative electrode, a CMC-Na having an Mw of 3.3×10⁵ was used instead of using the CMC-Na having an Mw of 4.0×10⁵, a battery was formed in a manner similar to that of Comparative Example 6.

### [Measurement of Initial Discharge Capacity]

The battery of each of Examples and Comparative Examples was charged/discharged under the following conditions, and an initial discharge capacity was obtained.

(1) Constant current charge was performed at 4 A until the battery voltage reached 4.1 V, and subsequently, a constant voltage charge was performed at 4.1 V (total 2 hours).
(2) Constant current discharge was performed at 2 A until the battery voltage reached 3.0 V, and subsequently, a constant voltage discharge was performed at 3.0 V (total 3 hours). The discharge capacity obtained at this stage was regarded as the initial discharge capacity.

### [Evaluation of High-Temperature Storage Characteristics]

A capacity retention rate of the battery, the initial discharge capacity of which was measured, was obtained by the following method.

(1) Constant current charge was performed at 4 A to a specified voltage so that the state of charge (SOC) was 80%, and subsequently, constant voltage charge was performed at the specified voltage (total 2 hours).
(2) The battery was stored at 75° C. and an SOC of 80% for 56 days.
(3) Constant current discharge was performed at 2 A until the battery voltage reached 3.0 V, and subsequently, constant voltage discharge was performed at 3.0 V (total 3 hours).
(4) Constant current charge was performed at 4 A until the battery voltage reached 4.1 V, and subsequently, constant voltage charge was performed at 4.1 V (total 2 hours).
(5) Constant current discharge was performed at 2 A until the battery voltage reached 3.0 V, and subsequently, constant voltage discharge was performed at 3.0 V (total 3 hours). The discharge capacity obtained at this stage was regarded as a discharge capacity after the storage, and the discharge capacity after the storage was divided by the initial discharge capacity to calculate the capacity retention rate after the high-temperature storage. In Table 1, as the capacity retention rate, a relative value obtained when the capacity retention rate of the battery in Comparative Example 4 is regarded as 100 is shown. [Evaluation of Low-Temperature Regeneration Characteristics].

The battery of each of Examples and Comparative Examples was charged under the following conditions, and the regeneration value was obtained.

(1) The battery was charged at 25° C. until the SOC reached 50%.
(2) A battery at an SOC of 50% was charged at −30° C. for 10 seconds at a current of each of 1.6C, 3.2C, 4.8C, 6.4C, 8.0C, and 9.6C.
(3) The battery voltage immediately after the charge performed for 10 seconds was measured and was plotted with each current value, and a current value IP (A) at a battery voltage (V) corresponding to an SOC of 100% was obtained. The current value IP thus obtained was multiplied by the battery voltage (V) corresponding to an SOC of 100%, so that the regeneration value (W) was calculated. In Table 1, as the regeneration value, a relative value obtained when the regeneration value of the battery in Comparative Example 4 is regarded as 100 is shown.

TABLE 1

| | | | | | HIGH- | LOW- |
|---|---|---|---|---|---|---|
| | FIRST | SECOND | | ADDITIVE TO | TEMPERATURE | TEMPERATURE |
| | AMORPHOUS | AMORPHOUS | | ELECTROLYTE | STORAGE | REGENERATION |
| | CARBON | CARBON | Mw OF CMC | LIQUID | CHARACTERISTICS | CHARACTERISTICS |
| EXAMPLE 1 | 3 PERCENT | 7 PERCENT | 4.0 × 10⁵ | YES | 111 | 113 |
| | BY MASS | BY MASS | | | | |
| EXAMPLE 2 | 3 PERCENT | 7 PERCENT | 3.7 × 10⁵ | YES | 109 | 114 |
| | BY MASS | BY MASS | | | | |
| EXAMPLE 3 | 3 PERCENT | 7 PERCENT | 4.3 × 10⁵ | YES | 113 | 112 |
| | BY MASS | BY MASS | | | | |
| COMPARATIVE | 3 PERCENT | — | 4.0 × 10⁵ | YES | 104 | 95 |
| EXAMPLE 1 | BY MASS | | | | | |
| COMPARATIVE | 3 PERCENT | — | 3.3 × 10⁵ | YES | 103 | 97 |
| EXAMPLE 2 | BY MASS | | | | | |
| COMPARATIVE | 3 PERCENT | — | 4.0 × 10⁵ | NO | 101 | 98 |
| EXAMPLE 3 | BY MASS | | | | | |
| COMPARATIVE | 3 PERCENT | — | 3.3 × 10⁵ | NO | 100 | 100 |
| EXAMPLE 4 | BY MASS | | | | | |
| COMPARATIVE | 3 PERCENT | 7 PERCENT | 3.3 × 10⁵ | YES | 104 | 115 |
| EXAMPLE 5 | BY MASS | BY MASS | | | | |
| COMPARATIVE | 3 PERCENT | 7 PERCENT | 4.0 × 10⁵ | NO | 102 | 108 |
| EXAMPLE 6 | BY MASS | BY MASS | | | | |
| COMPARATIVE | 3 PERCENT | 7 PERCENT | 3.3 × 10⁵ | NO | 97 | 110 |
| EXAMPLE 7 | BY MASS | BY MASS | | | | |

*ADDITIVE TO ELECTROLYTE LIQUID: LiBOB and LiPF₂O₂

As shown in Table 1, all the batteries of Examples are excellent in high-temperature storage characteristics and low-temperature regeneration characteristics. In the battery of Example 1, since the two types of amorphous carbons coat the surface of the graphite particle, the electron conductivity of the particle is increased, and hence, a good quality protective coating film derived from LiBOB and LIPF₂O₂ is uniformly formed on the surface of the coated graphite particle. Accordingly, it is believed that preferable low-temperature regeneration characteristics can be obtained. In addition, it is also believed that since the surface of the second amorphous carbon is efficiently coated with a CMC having a specific molecular weight, the reaction between the second amorphous carbon and the non-aqueous electrolyte is suppressed, and preferable high-temperature storage characteristics are obtained.

In addition, in the range of an Mw from 3.7×10⁵ to 4.3×10⁵, when the molecular weight of the CMC was decreased, the low-temperature regeneration characteristics tended to be further improved, and when the molecular weight of the CMC was increased, the high-temperature storage characteristics tended to be further improved (Examples 2 and 3).

On the other hand, in the case of Comparative Examples 1 and 2 in which the second amorphous carbon was not present on the surface of the graphite particle, regardless of Mw of the CMC, the high-temperature storage characteristics and the low-temperature regeneration characteristics were seriously degraded as compared to those of Examples. In particular, the degradation of the low-temperature regeneration characteristics was significant. In addition, in the case in which the second amorphous carbon was not present, when LiBOB and LIPF₂O₂ were not added to the non-aqueous electrolyte liquid, unexpectedly, preferable low-temperature regeneration characteristics could be obtained (Comparative Examples 3 and 4). On the other hand, when LiBOB and LIPF₂O₂ were not present, a good quality protective coating film was further difficult to form, and the high-temperature storage characteristics were further degraded as compared to those of Comparative Examples 1 and 2.

In addition, in the case of Comparative Example 5 in which the CMC having an Mw of less than 3.7×10⁵ was used, although preferable low-temperature regeneration characteristics could be obtained by the effect of the amorphous carbons, the second amorphous carbon was not sufficiently coated with the CMC, and hence, the high-temperature storage characteristics were remarkably degraded as compared to those of Examples. In the case of Comparative Examples 6 and 7 in which LiBOB and LIPF₂O₂ were not added to the non-aqueous electrolyte liquid, in particular, the high-temperature storage characteristics were seriously degraded as compared to those of Comparative Example 5. In addition, in the case in which the CMC having an Mw of less than 3.7×10⁵ was used (Comparative Example 7), the degradation in high-temperature storage characteristics was significant.

While detailed embodiments have been used to illustrate the present invention, to those skilled in the art, however, it will be apparent from the foregoing disclosure that various changes and modifications can be made therein without departing from the spirit and scope of the invention. Furthermore, the foregoing description of the embodiments according to the present invention is provided for illustration only, and is not intended to limit the invention.

What is claimed is:

1. A non-aqueous electrolyte secondary battery comprising:
a positive electrode:
a negative electrode; and
a non-aqueous electrolyte,
wherein the negative electrode contains: coated graphite particles in each of which a first amorphous carbon and a second amorphous carbon having a higher electrical conductivity than that of the first amorphous carbon are fixed to a surface of a graphite particle; and a carboxymethyl cellulose having a weight average molecular weight of 3.7×10⁵ to 4.3×10⁵ or its salt, and
the non-aqueous electrolyte contains a difluorophosphate and a lithium salt which converts an oxalato complex to an anion.

2. The non-aqueous electrolyte secondary battery according to claim 1, wherein the first amorphous carbon forms an amorphous carbon coating film on the surface of the graphite particle, and the second amorphous carbon forms amorphous carbon particles fixed to the surface thereof.

3. The non-aqueous electrolyte secondary battery according to claim 1, wherein the first amorphous carbon includes a fired product of pitch.

4. The non-aqueous electrolyte secondary battery according to claim 1, wherein the second amorphous carbon includes carbon black.

5. The non-aqueous electrolyte secondary battery according to claim 1, wherein the difluorophosphate includes lithium difluorophosphate.

6. The non-aqueous electrolyte secondary battery according to claim 1, wherein the lithium salt which converts an oxalato complex to an anion includes lithium bis(oxalato)borate.

7. A method for manufacturing a non-aqueous electrolyte secondary battery which includes a positive electrode, a negative electrode, a non-aqueous electrolyte, and a battery case, the method comprising:
forming the negative electrode which contains: coated graphite particles in each of which a first amorphous carbon and a second amorphous carbon having a higher electrical conductivity than that of the first amorphous carbon are fixed to a surface of a graphite particle; and a carboxymethyl cellulose having a weight average molecular weight of 3.7×10⁵ to 4.3×10⁵ or its salt, and
receiving the non-aqueous electrolyte which contains a difluorophosphate and a lithium salt which converts an oxalato complex to an anion in the battery case.
